(19) United States
(12) Patent Application Publication
(10) Pub. No.: US 2025/0263056 A1
(43) Pub. Date: Aug. 21, 2025

(54) BRAKE ARCHITECTURE FOR PARKING BRAKE BACKUP RESPONSE

(71) Applicant: Ford Global Technologies, LLC, Dearborn, MI (US)

(72) Inventors: Travis Matthew Pearce, Wyandotte, MI (US); Todd Anthony Brittingham, White Lake, MI (US)

(21) Appl. No.: 18/581,761

(22) Filed: Feb. 20, 2024

(51) Int. Cl. B60T 15/04; B60T 1/00; B60T 1/093; B60T 11/10; B60T 17/22

(52) U.S. Cl. CPC B60T 15/041; B60T 1/005; B60T 11/102; B60T 1/093; B60T 17/221; B60T 2270/402

(57) ABSTRACT

A vehicle braking system includes a first hydraulic brake assembly associated with a first wheel, a second hydraulic brake assembly associated with a second wheel, a third brake assembly associated with a third wheel, a fourth brake assembly associated with a fourth wheel, a brake control module operably coupled to the first and second hydraulic brake assemblies to control primary operation of the first and second hydraulic brake assemblies and operably coupled to the third and fourth brake assemblies to provide brake torque application for parking brake functionality, and a backup brake actuator operably coupled to a first locking valve disposed in hydraulic lines supplying at least one among the first and second hydraulic brake assemblies and the third and fourth brake assemblies. Responsive to an indication of loss or degradation of the parking brake functionality, the brake control module triggers the backup brake actuator to lock hydraulic pressure in the hydraulic lines supplying the at least one among the first and second hydraulic brake assemblies and the third and fourth brake assemblies for backup parking brake functionality.

### TECHNICAL FIELD

Example embodiments generally relate to vehicle braking systems and, more particularly, relate to a system that provides redundant parking braking functionality in response to a loss of or reduction in efficiency of parking brake operation.

### BACKGROUND

Park-by-brake functionality, in which the vehicle relies on the rear brake electric parking actuators to secure the vehicle, has become desirable due to its ability to obviate the use of transmission parking pawls. This is especially true for electric/battery electric vehicles (BEVs), and industry trends in general are moving away from the use of parking pawls.

In vehicles with park-by-brake functionality, complicated wiring routing or other protection strategies are typically implemented to design against the possibility of a double loss of both rear brakes. Doing so ensures that no single event can take out both rear brake circuits.

Thus, it may be desirable to develop an architecture that provides an ability to ensure redundant braking capability for a park-by-brake system without complicated wiring strategies.

### BRIEF SUMMARY OF SOME EXAMPLES

In accordance with an example embodiment, a vehicle braking system may be provided. The vehicle braking system may include a first hydraulic brake assembly associated with a first wheel, a second hydraulic brake assembly associated with a second wheel, a third brake assembly associated with a third wheel, a fourth brake assembly associated with a fourth wheel, a brake control module operably coupled to the first and second hydraulic brake assemblies to control primary operation of the first and second hydraulic brake assemblies and operably coupled to the third and fourth brake assemblies to provide brake torque application for parking brake functionality, and a backup brake actuator operably coupled to a first locking valve disposed in hydraulic lines supplying at least one among the first and second hydraulic brake assemblies and the third and fourth brake assemblies. Responsive to an indication of loss or degradation of the parking brake functionality, the brake control module triggers the backup brake actuator to lock hydraulic pressure in the hydraulic lines supplying the at least one among the first and second hydraulic brake assemblies and the third and fourth brake assemblies for backup parking brake functionality.

In another example embodiment, a method of providing parking brake functionality backup in a vehicle braking system comprising a first hydraulic brake assembly associated with a first wheel, a second hydraulic brake assembly associated with a second wheel, a third brake assembly associated with a third wheel, and a fourth brake assembly associated with a fourth wheel may be provided. The method may include receiving an indication of loss or degradation of the parking brake functionality at a brake control module operably coupled to the first and second hydraulic brake assemblies to control primary operation of the first and second hydraulic brake assemblies, and operably coupled to the third and fourth brake assemblies to provide brake torque application for parking brake functionality. The method may also include actuating a backup brake actuator operably coupled to a first locking valve disposed in hydraulic lines supplying at least one among the first and second hydraulic brake assemblies and the third and fourth brake assemblies to lock hydraulic pressure in the hydraulic lines supplying the at least one among the first and second hydraulic brake assemblies and the third and fourth brake assemblies for backup parking brake functionality.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a vehicle control system in accordance with an example embodiment;

FIG. 2 illustrates a block diagram of some components of the vehicle control system of FIG. 1 in accordance with an example embodiment;

FIG. 3A illustrates a schematic diagram of a hydraulic brake shut-off valve with a linear actuator in an open position in accordance with an example embodiment;

FIG. 3B illustrates a schematic diagram of the hydraulic brake shut-off valve with the linear actuator in a closed position in accordance with an example embodiment;

FIG. 4A illustrates a schematic diagram of another hydraulic brake shut-off valve with a rotary actuation in an open position in accordance with an example embodiment;

FIG. 4B illustrates a schematic diagram of the hydraulic brake shut-off valve with a rotary actuator in the closed position in accordance with an example embodiment;

FIG. 4C illustrates a schematic diagram of another hydraulic brake shut-off valve with a concentric valve in an open position in accordance with an example embodiment;

FIG. 4D illustrates a schematic diagram of the hydraulic brake shut-off valve with the concentric valve in the closed position in accordance with an example embodiment; and

FIG. 5 illustrates a block diagram of a method for providing parking brake functionality backup in a vehicle braking system in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

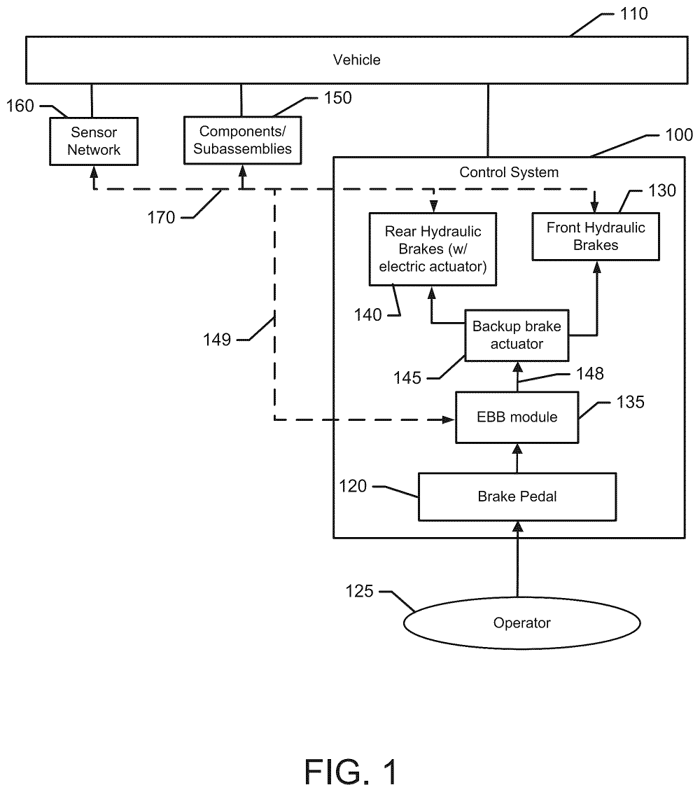

FIG. 1 illustrates a block diagram of a vehicle control system 100 of an example embodiment. The components of the control system 100 may be incorporated into a vehicle 110 (e.g., via being operably coupled to a chassis of the vehicle 110, various components of the vehicle 110 and/or electronic control systems of the vehicle 110). Of note, although the components of FIG. 1 may be operably coupled to the vehicle 110, it should be appreciated that such connection may be either direct or indirect. Moreover, some of the components of the control system 100 may be connected to the vehicle 110 via intermediate connections to other components either of the chassis or of other electronic and/or mechanical systems or components.

The control system 100 may include one or more input devices in the form of one or more control pedals. In some embodiments, the control pedals may include a brake pedal 120 that is generally foot operated by an operator 125 to initiate braking forces, or braking torque application at the wheels of the vehicle 110. The brake pedal 120 may be operably coupled to a set of front hydraulic brakes 130 (e.g., for each of the front wheels) via mechanical, electrical and/or hydraulic connections under control of an electronic brake booster (EBB) module 135. The EBB module 135 may also be operably coupled to a set of rear hydraulic brakes 140 (e.g., for each of the rear wheels) that may include an electric actuator. The electric actuator may be used to actuate the rear hydraulic brakes 140 for parking, when actuated. In some cases, rear electromechanical brakes (EMBs) may be substituted for the rear hydraulic brakes 140, and example embodiments described herein may still be applicable. Moreover, the EBB module 135 may be replaced with any suitable booster or antilock brakes system (ABS) module that employs a hydraulic braking component as described herein. Thus, it should be understood that the EBB module 135 is merely an example of a brake control module (of which the ABS module or other suitable booster are also alternative examples).

As noted above, given that the electric actuation of the rear hydraulic brakes 140 for parking must normally be redundantly and complexly wired and otherwise constructed. To reduce complexity, and enhance performance, it may be possible to instead employ a backup brake actuator 145, which may lock hydraulic pressure for brake application to the front and rear hydraulic brakes 130 and 140 in response to a trigger signal 148 from the EBB module 135, or from any other component of the vehicle 110 (e.g., a vehicle controller or control module). The trigger signal 148 may be provided whenever an indication 149 is received that the parking brake system's operability is compromised or otherwise anything other than operating normally. For example, the trigger signal 148 may be provided if power to the electric actuation of the rear hydraulic brakes 140 (e.g., for parking application). Alternatively or additionally, the indication 149 may take the form of diagnostic codes provided to a vehicle control module (VCM), an electronic control unit (ECU) or other controller of the vehicle 110 (or control system 100) to indicate lost or reduced capability for the parking brake system may cause the trigger signal 148 to be produced.

Notably, in some cases, the control system 100 may be configured to perform other tasks related or not related to propulsive and braking control or performance management. However, at least in relation to its functions associated with propulsive and/or braking control, the control system 100 may receive information that is used to determine vehicle status from various components or subassemblies 150 of the vehicle 110. Additionally or alternatively, various sensors that may be operably coupled to the components or subassemblies 150 may be included, and may provide input to the control system 100 that is used in determining vehicle status. Such sensors may be part of a sensor network 160 and sensors of the sensor network 160 may be operably coupled to the control system 100 (and/or the components or subassemblies 150) via one or more instances of a vehicle communication bus (e.g., a controller area network (CAN) bus) 170.

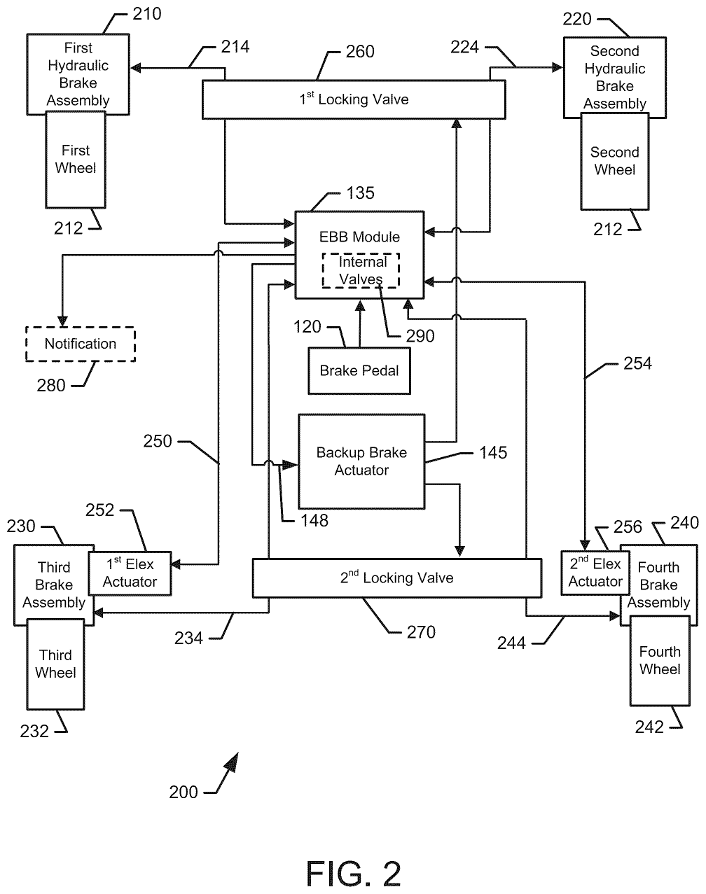

The components or subassemblies 150 may include, for example, a braking system (of which the parking brake system may be a sub-system), a propulsion system and/or a wheel assembly of the vehicle 110. The braking system may be configured to provide braking inputs to braking components of the vehicle 110, and includes the components discussed herein. One or more corresponding sensors of the sensor network 160 that may be operably coupled to the brake system and/or the wheel assembly may provide information relating to brake torque, brake torque rate, vehicle velocity (including rate of change of velocity), front/rear wheel speeds, vehicle pitch, etc. Inputs from the sensors of the sensor network 160 may be provided to the control system 100 to enable the control system 100 to provide various primary and secondary (or backup) control functions related to the components or subassemblies 150. Accordingly, for example, the control system 100 may be able to receive numerous different parameters, indications and other information that may be related to or indicative of different situations or conditions associated with vehicle status (including providing the indication 149 to the EBB module 135). The control system 100 may also receive information indicative of the intent of the operator 125 relative to control of various aspects of operation of the vehicle 110 and then be configured to use the information received to provide instructions to control responses to the situations or conditions determined. The control system 100 of FIG. 1 may be similar to conventional systems in many respects, except that, the control system 100 may be modified to respond to situations in which backup operability is required for the rear hydraulic brakes 140 with respect to parking brake system functionality as described in greater detail in reference to FIGS. 2-4B.

FIG. 2 illustrates a block diagram of various components of a control system 200, which may be considered either a specific example of the control system 100 of FIG. 1, or a portion thereof that is associated with a vehicle braking system. The control system 200 may include the brake pedal 120, which may have the corresponding brake pedal position sensor (not shown) for determining a position of the brake pedal 120 and providing a signal or input to the EBB module 135 that is indicative of the position determined. However, in other examples, pedal position of the brake pedal 120 may be hydraulically or mechanically communicated to the EBB module 135.

The front hydraulic brakes 130 of FIG. 1 may include, for example, a first hydraulic brake assembly 210 associated with a first wheel 212 (e.g., a left front wheel) of the vehicle 110, and a second hydraulic brake assembly 220 associated with a second wheel 222 (e.g., a right front wheel) of the vehicle 110. Each of the first and second hydraulic brake assemblies 210 and 220 may include respective instances or a brake caliper or drum for providing frictional braking of the corresponding first and second wheels 212 and 222 associated therewith. Hydraulic power for actuating the first and second hydraulic brake assemblies 210 and 220 may be provided from the EBB module 135 via respective instances of hydraulic lines (e.g., first hydraulic lines 214 and second hydraulic lines 224). Each of the first and second wheels 212 and 222, respectively, associated with the first and second hydraulic brake assemblies 210 and 220 may also have a corresponding wheel speed sensor associated therewith to measure the wheel speed of the corresponding ones of the first and second wheels 212 and 222 to provide information on wheel speed measured to the EBB module 135.

The control system 200 may also include a third brake assembly 230 associated with a third wheel 232 (e.g., a left rear wheel) and a fourth brake assembly 240 associated with a fourth wheel 242 (e.g., a right rear wheel). The third and fourth brake assemblies 230 and 240 are examples of the rear hydraulic brakes 140 of FIG. 1. However, as noted above, the third and fourth brake assemblies 230 and 240 may be replaced by respective instances of EMBs in some cases.

When the third and fourth brake assemblies 230 and 240 are embodied as hydraulic brake assemblies, each of the third and fourth brake assemblies 230 and 240 may include respective instances or a brake caliper or drum for providing frictional braking of the corresponding third and fourth wheels 232 and 242 associated therewith. Hydraulic power for actuating the third and fourth brake assemblies 230 and 240 may be provided from the EBB module 135 via respective instances of hydraulic lines (e.g., third hydraulic lines 234 and fourth hydraulic lines 244). Each of the third and fourth wheels 232 and 242, respectively, associated with the third and fourth brake assemblies 230 and 240 may also have a corresponding wheel speed sensor associated therewith to measure the wheel speed of the corresponding ones of the third and fourth wheels 232 and 242 to provide information on wheel speed measured to the EBB module 135.

Unlike the first and second hydraulic brake assemblies 210 and 220, the third and fourth brake assemblies 230 and 240 may each also be operable via an electrical actuation signal that may be used, for example, for applying clamp force as a parking brake. As noted above, this may be an alternative to the use of transmission parking pawls. In such an example, the EBB module 135 may provide the electrical actuation signal via a first electric line 250 to a first electrical actuator 252 associated with the third brake assembly 230. The EBB module 135 may also provide the electrical actuation signal via a second electric line 254 to a second electrical actuator 256 associated with the fourth brake assembly 240. The first and second electrical actuators 252 and 256 may, when actuated, may employ a local electrical motor or other motive force provider, to apply brake pressure to the respective instances or the brake caliper or drum for providing frictional braking of the corresponding third and fourth wheels 232 and 242 associated therewith as a parking brake.

As noted above, redundancy in the event of the loss of the parking brake functionality associated with the third and fourth brake assemblies 230 and 240 is typically provided for by complex wiring aimed at preventing loss of power to provide the electric actuation signal. This added complexity may be considered inefficient and undesirable. To provide backup braking power for parking brake functionality, example embodiments may employ the backup brake actuator 145 of FIG. 1, which is also shown in FIG. 2. As shown in FIG. 2, the backup brake actuator 145 may be operably coupled to the EBB module 135 to receive the trigger signal 148 from the EBB module 135 (e.g., responsive to the indication 149 of lost or reduced capability for the parking brake system). The backup brake actuator 145 may then actuate a first locking valve 260 associated with the first and second hydraulic lines 214 and 224, and/or actuate a second locking valve 270 associated with the third and fourth hydraulic lines 234 and 244.

When actuated, the first locking valve 260 may lock hydraulic pressure in the first and second hydraulic lines 214 and 224, and the second locking valve 270 may lock hydraulic pressure in the third and fourth hydraulic lines 234 and 244. In particular, assuming the operator 125 is already pressing the brake pedal 120, hydraulic pressure will normally already be built up in the first, second, third and fourth hydraulic lines 214, 224, 234, and 244. This already built up pressure will simply then be locked in by actuating or closing the first and second locking valves 260 and 270 between the first and second locking valves 260 and 270 and the braking components associated with the first, second, third and fourth wheels 212, 222, 232 and 242. This locking of pressure may provide a backup parking brake functionality (responsive to the indication 149 and trigger signal 148), and may also be accompanied by a notification 280, which may be provided to the operator 125. The notification 280 may indicate to the operator 125 that service should be performed on the parking brake functionality.

However, if for any reason the operator 125 is not pressing the brake pedal 120 when the indication 149 is received, the EBB module 135 (or some other controller in the system 200) may cause pressure to be built up in the necessary hydraulic lines before issuing the trigger signal 148 and locking the pressure in the hydraulic lines. In this regard, for example, a threshold pressure may be set above which operation of the locking of pressure in the corresponding hydraulic lines will be enabled to act as a parking brake backup. When the indication 149 is received, the EBB module 135 may first check the current pressure in the hydraulic lines and, if the current pressure is above the threshold pressure, the trigger signal 148 may be issued. However, if the current pressure is below the threshold pressure, then the EBB module 135 may direct the raising of such pressure until the threshold pressure is exceeded. After the threshold pressure is exceeded, the trigger signal 148 may be used to lock the pressure in the corresponding hydraulic lines to act as a backup parking brake.

Notably, the structure of FIG. 2 indicates that each of the first locking valve 260 and the second locking valve 270 operates to isolate or lock two hydraulic lines (e.g., the first locking valve 260 locks the first and second hydraulic lines 214 and 224, and the second locking valve 270 locks the third and fourth hydraulic lines 234 and 244). However, one locking valve could alternatively be provided for each respective one of the hydraulic lines. In such an example, the first locking valve 260 may represent a pair of locking valves that are independently or simultaneously operated with respect to the first and second hydraulic lines 214 and 224. Similarly, the second locking valve 270 may represent a pair of locking valves that are independently or simultaneously operated with respect to the third and fourth hydraulic lines 234 and 244.

Additionally, although FIG. 2 shows both the first and second locking valves 260 and 270 as external valves (with respect to the EBB module 135), it is also possible for the first and second locking valves to be alternatively embodied as internal valves 290. In the case of an internal structure, the internal valves 290 are located internal to the EBB module 135. In this regard, for example, the EBB module 135 may include a header or other hydraulic fluid distribution assembly that distributes hydraulic fluid (and pressure) to the first, second, third and fourth hydraulic lines 214, 224, 234 and 244. The internal valves 290 may be actuated by the backup brake actuator 145 responsive to the trigger signal 148, and lock pressure in respective ones of the first, second, third and fourth hydraulic lines 214, 224, 234 and 244 that are isolated by the actuation. Thus, the internal valves 290 may isolate or lock respective ones of the first, second, third and fourth hydraulic lines 214, 224, 234 and 244 internal to the EBB module 135.

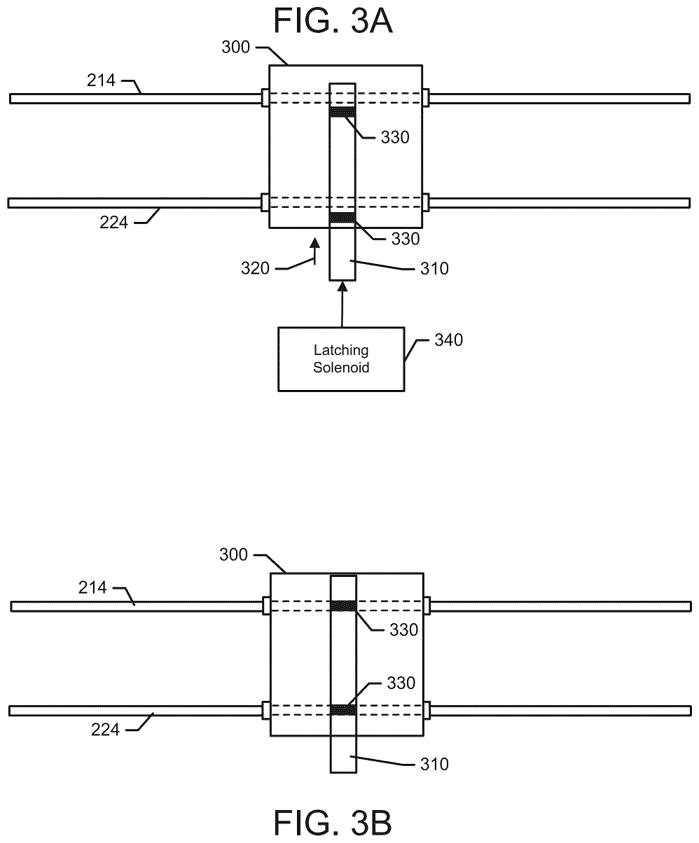

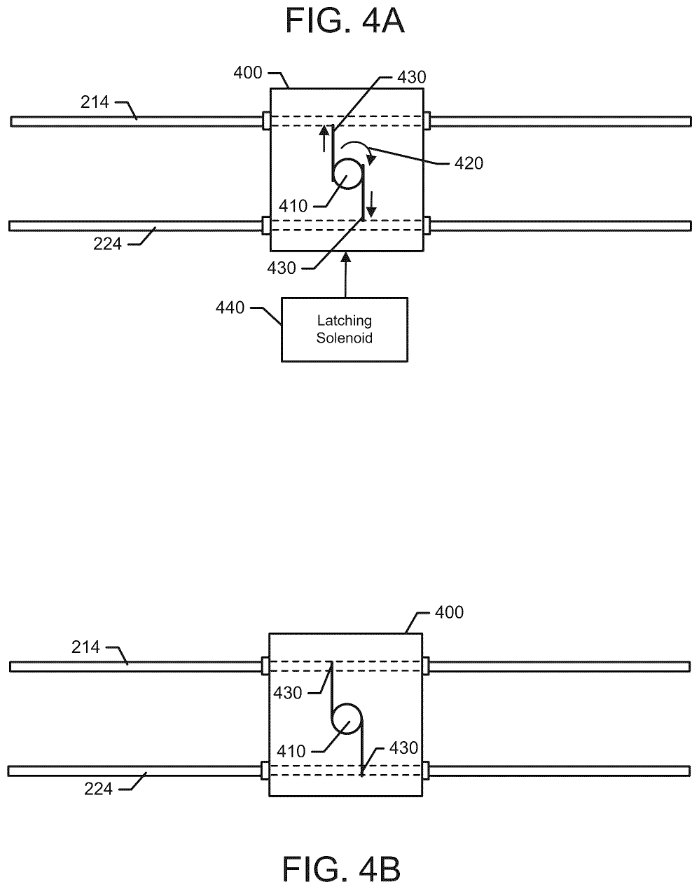

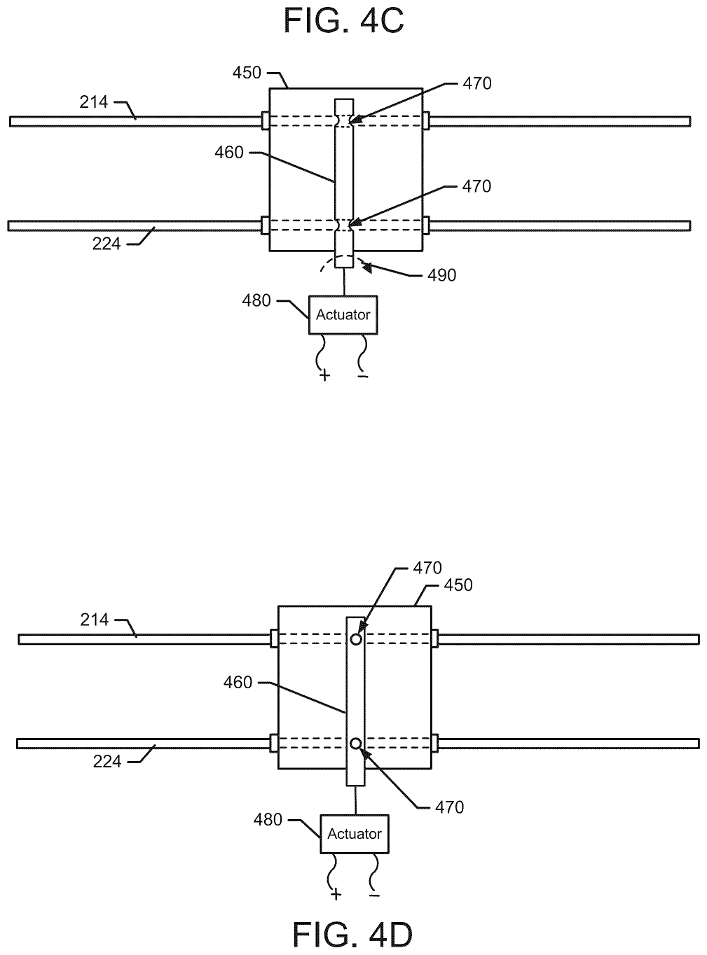

Although the specific structures used to implement the first and second locking valves 260 and 270 may vary in different embodiments, some examples of structures that may be employed are shown in FIGS. 3A, 3B, 4A and 4B. In this regard, FIGS. 3A and 3B illustrate a hydraulic brake shut-off valve 300 with a locking body 310 that moves in the direction of arrow 320 in order to lock pressure in the first and second hydraulic lines 214 and 224. The locking body 310 may include blocking portions 330 that interrupt flow through the first and second hydraulic lines 214 and 224 when in the closed or locked position of FIG. 3B, but allow flow through the first and second hydraulic lines 214 and 224 when in the open or unlocked position of FIG. 3A. The locking body 310 of this example embodiment operates similar to a linear actuator in that the locking body 310, when actuated, moves linearly between the open and closed positions.

In some embodiments, it may be desirable for the state of the hydraulic brake shut-off valve 300 (and particularly the position of the locking body 310) to remain unchanged except in response to a specific instruction to change state. Thus, for example, if the vehicle 110 is being held on a slope due to operation of the first and/or second locking valve 260/270 and the battery of the vehicle 110 is exhausted such that power is lost, the state of the first and/or second locking valve 260/270 will not change. This state stability may be achieved, for example, by implementing the backup brake actuator 145 in the form of a latching solenoid 340. Thus, if the hydraulic brake shut-off valve 300 is in the open or unlocked state of FIG. 3A when power is lost, the latching solenoid 340 will maintain the locking body 310 in the position shown in FIG. 3A until power is restored and the trigger signal 148 can be applied to change state. If instead the hydraulic brake shut-off valve 300 is in the closed or locked state of FIG. 3B when power is lost, the latching solenoid 340 will maintain the locking body 310 in the position shown in FIG. 3B until power is restored and the trigger signal 148 can be applied to change state.

FIGS. 4A and 4B illustrate an example of alternative structures that may be employed to implement the first and second locking valves 260 and 270. Instead of moving linearly responsive to actuation, rotational motion is instead employed in this example. In particular, FIGS. 4A and 4B illustrate a hydraulic brake shut-off valve 400 with a locking body 410 that moves rotationally in the direction of arrow 420 about a pivot axis of the locking body 410. The locking body 410 includes fixed points of connection to blocking portions 430 that are pivoted outward (in FIG. 4B) or drawn inward (in FIG. 4A) to transition between states of the hydraulic brake shut-off valve 400. The blocking portions 430 of FIG. 4B translate outward on rotation of the locking body 410 in order to lock pressure in the first and second hydraulic lines 214 and 224 when in the closed or locked position of FIG. 4B, but allow flow through the first and second hydraulic lines 214 and 224 when in the open or unlocked position of FIG. 4A. As shown in FIG. 4A, a latching solenoid 440 may be employed to actuate or rotate the locking body 410 so that unwanted state changes are prevented even if power is lost.

FIGS. 4A and 4B illustrate an example in which the rotational movement 420 is tangential and/or perpendicular to the blocking portions 430. Alternatively, the rotational movement can be concentric with the blocking portions so that the blocking portions rotate 90 degrees to either block or allow flow through the valve depending on control signal logic. An example of such an alternative concept is shown in FIGS. 4C and 4D. In this regard, the hydraulic brake shut-off valve 450 of FIGS. 4C and 4D includes a lock body 460 that is essentially a cylindrical rotatable body with through-holes 470 that pass entirely through the lock body 460 and align the through-holes 470 with the first and second hydraulic lines 214 and 224 to permit flow when in the open position of FIG. 4C. However, responsive to an actuation signal from actuator 480, the lock body 460 rotates about its axis as shown by arrow 490 such that the through-holes 470 are not aligned with the first and second hydraulic lines 214 and 224 and flow is therefore not permitted through the first and second hydraulic lines 214 and 224 in the closed position of FIG. 4D. Thus, for example, the hydraulic brake shut-off valve 450 of FIGS. 4C and 4D would conceptually operate like an electrically actuated dual (or single) circuit ball or cylinder valve.

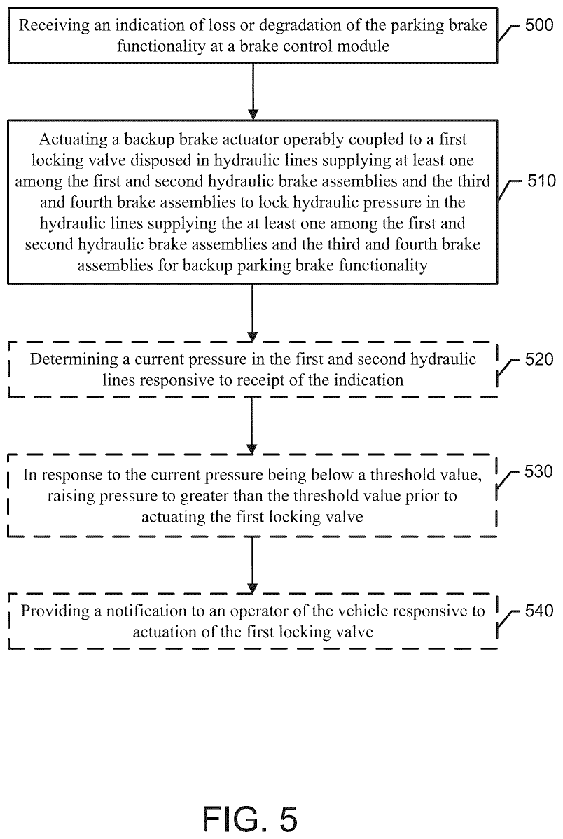

FIG. 5 illustrates a method of providing parking brake functionality backup in a vehicle braking system such as that shown, for example in FIG. 2. Thus, for example, the system may include a first hydraulic brake assembly associated with a first wheel, a second hydraulic brake assembly associated with a second wheel, a third brake assembly associated with a third wheel, and a fourth brake assembly associated with a fourth wheel. The method may include receiving an indication of loss or degradation of the parking brake functionality at a brake control module (e.g., the EBB module 135) at operation 500. The brake control module may be operably coupled to the first and second hydraulic brake assemblies to control primary operation of the first and second hydraulic brake assemblies, and operably coupled to the third and fourth brake assemblies to provide brake torque application for parking brake functionality. Notably, if the third and fourth brake assemblies are also hydraulic in nature, then the brake control module may also provide brake torque application for normal operation of the third and fourth brake assemblies as well. The method may further include actuating a backup brake actuator operably coupled to a first locking valve disposed in hydraulic lines supplying at least one among the first and second hydraulic brake assemblies and the third and fourth brake assemblies to lock hydraulic pressure in the hydraulic lines supplying the at least one among the first and second hydraulic brake assemblies and the third and fourth brake assemblies for backup parking brake functionality at operation 510. The method may, in some cases, include additional (optional) operations, some of which are shown in dashed lines in FIG. 5. In this regard, for example, the method may further include determining a current pressure in the first and second hydraulic lines responsive to receipt of the indication at operation 520 and, in response to the current pressure being below a threshold value, raising pressure to greater than the threshold value prior to actuating the first locking valve at operation 530. The method may also or alternatively include providing a notification to an operator of the vehicle responsive to actuation of the first locking valve at operation 540.

A vehicle braking system for a vehicle may therefore be provided. The vehicle braking system may include a first hydraulic brake assembly associated with a first wheel, a second hydraulic brake assembly associated with a second wheel, a third brake assembly associated with a third wheel, a fourth brake assembly associated with a fourth wheel, a brake control module operably coupled to the first and second hydraulic brake assemblies to control primary operation of the first and second hydraulic brake assemblies and operably coupled to the third and fourth brake assemblies to provide brake torque application for parking brake functionality, and a backup brake actuator operably coupled to a first locking valve disposed in hydraulic lines supplying at least one among the first and second hydraulic brake assemblies and the third and fourth brake assemblies. Responsive to an indication of loss or degradation of the parking brake functionality, the brake control module triggers the backup brake actuator to lock hydraulic pressure in the hydraulic lines supplying at least one among the first and second hydraulic brake assemblies and the third and fourth brake assemblies for backup parking brake functionality.

The system of some embodiments may include additional features, modifications, augmentations and/or the like to achieve further objectives or enhance performance of the system. The additional features, modifications, augmentations and/or the like may be added in any combination with each other. Below is a list of various additional features, modifications, and augmentations that can each be added individually or in any combination with each other. For example, the hydraulic supply lines may include a first hydraulic supply line operably coupled to the first hydraulic brake assembly and a second hydraulic supply line operably coupled to the second hydraulic brake assembly, and the first locking valve, when actuated, may simultaneously lock pressure in both the first and second hydraulic supply lines. In an example embodiment, the hydraulic supply lines may include a third hydraulic supply line operably coupled to the third brake assembly and a fourth hydraulic supply line operably coupled to the fourth brake assembly, and the vehicle braking system may further include a second locking valve that, when actuated, simultaneously locks pressure in both the third and fourth hydraulic supply lines. In some cases, the first and second locking valves may be internal to the brake control module. However, in some other alternatives, the first and second locking valves may be external to the brake control module. In an example embodiment, the first locking valve comprises a locking body that is repositioned linearly to simultaneously lock pressure in both the first and second hydraulic supply lines. However, in some other alternatives, the first locking valve comprises a locking body that rotates about an axis to simultaneously lock pressure in both the first and second hydraulic supply lines. In an example embodiment, the brake control module determines a current pressure in the first and second hydraulic lines responsive to receipt of the indication and, in response to the current pressure being below a threshold value, raising pressure to greater than the threshold value before actuating the first locking valve. In some cases, the third brake assembly and the fourth brake assembly are each electromechanical brake assemblies, and responsive to the indication, the brake control module triggers the first locking valve to simultaneously lock pressure in both the first and second hydraulic supply lines. In an example embodiment, the brake control module may provide a notification to an operator of the vehicle responsive to actuation of the first locking valve. In some cases, the backup brake actuator may include a latching solenoid.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A vehicle braking system comprising:
a first hydraulic brake assembly associated with a first wheel;
a second hydraulic brake assembly associated with a second wheel;
a third brake assembly associated with a third wheel;
a fourth brake assembly associated with a fourth wheel;
a brake control module operably coupled to the first and second hydraulic brake assemblies to control primary operation of the first and second hydraulic brake assemblies, and operably coupled to the third and fourth brake assemblies to provide brake torque application for parking brake functionality; and
a backup brake actuator operably coupled to a first locking valve disposed in hydraulic lines supplying at least one among the first and second hydraulic brake assemblies and the third and fourth brake assemblies,
wherein, responsive to an indication of loss or degradation of the parking brake functionality, the brake control module triggers the backup brake actuator to lock hydraulic pressure in the hydraulic lines supplying the at least one among the first and second hydraulic brake assemblies and the third and fourth brake assemblies for backup parking brake functionality.

2. The vehicle braking system of claim 1, wherein the hydraulic supply lines include a first hydraulic supply line operably coupled to the first hydraulic brake assembly and a second hydraulic supply line operably coupled to the second hydraulic brake assembly, and
wherein the first locking valve, when actuated, simultaneously locks pressure in both the first and second hydraulic supply lines.

3. The vehicle braking system of claim 2, wherein the hydraulic supply lines include a third hydraulic supply line operably coupled to the third brake assembly and a fourth hydraulic supply line operably coupled to the fourth brake assembly, and
wherein the vehicle braking system further includes a second locking valve that, when actuated, simultaneously locks pressure in both the third and fourth hydraulic supply lines.

4. The vehicle braking system of claim 3, wherein the first and second locking valves are internal to the brake control module.

5. The vehicle braking system of claim 3, wherein the first and second locking valves are external to the brake control module.

6. The vehicle braking system of claim 2, wherein the first locking valve comprises a locking body that is repositioned linearly to simultaneously lock pressure in both the first and second hydraulic supply lines.

7. The vehicle braking system of claim 2, wherein the first locking valve comprises a locking body that rotates about an axis to simultaneously lock pressure in both the first and second hydraulic supply lines.

8. The vehicle braking system of claim 2, wherein the brake control module determines a current pressure in the first and second hydraulic lines responsive to receipt of the indication and, in response to the current pressure being below a threshold value, raising pressure to greater than the threshold value before actuating the first locking valve.

9. The vehicle braking system of claim 2, wherein the third brake assembly and the fourth brake assembly are each electromechanical brake assemblies, and
wherein responsive to the indication, the brake control module triggers the first locking valve to simultaneously lock pressure in both the first and second hydraulic supply lines.

10. The vehicle braking system of claim 1, wherein the first locking valve is internal to the brake control module.

11. The vehicle braking system of claim 1, wherein the first locking valve is external to the brake control module.

12. The vehicle braking system of claim 1, wherein the brake control module provides a notification to an operator of the vehicle responsive to actuation of the first locking valve.

13. The vehicle braking system of claim 1, wherein the backup brake actuator comprises a latching solenoid.

14. A method of providing parking brake functionality backup in a vehicle braking system comprising a first hydraulic brake assembly associated with a first wheel, a second hydraulic brake assembly associated with a second wheel, a third brake assembly associated with a third wheel, and a fourth brake assembly associated with a fourth wheel, the method comprising:
receiving an indication of loss or degradation of the parking brake functionality at a brake control module operably coupled to the first and second hydraulic brake assemblies to control primary operation of the first and second hydraulic brake assemblies, and operably coupled to the third and fourth brake assemblies to provide brake torque application for parking brake functionality; and
actuating a backup brake actuator operably coupled to a first locking valve disposed in hydraulic lines supplying at least one among the first and second hydraulic brake assemblies and the third and fourth brake assemblies to lock hydraulic pressure in the hydraulic lines supplying the at least one among the first and second hydraulic brake assemblies and the third and fourth brake assemblies for backup parking brake functionality.

15. The method of claim 14, wherein the hydraulic supply lines include a first hydraulic supply line operably coupled to the first hydraulic brake assembly and a second hydraulic supply line operably coupled to the second hydraulic brake assembly, and
wherein the first locking valve, when actuated, simultaneously locks pressure in both the first and second hydraulic supply lines.

16. The method of claim 15, wherein the hydraulic supply lines include a third hydraulic supply line operably coupled to the third brake assembly and a fourth hydraulic supply line operably coupled to the fourth brake assembly, and
wherein a second locking valve is actuated to simultaneously lock pressure in both the third and fourth hydraulic supply lines.

17. The method of claim 15, further comprising:
determining a current pressure in the first and second hydraulic lines responsive to receipt of the indication; and
in response to the current pressure being below a threshold value, raising pressure to greater than the threshold value prior to actuating the first locking valve.

18. The method of claim 15, further comprising providing a notification to an operator of the vehicle responsive to actuation of the first locking valve.

19. The method of claim 14, wherein actuating the backup brake actuator comprises providing a state change signal to a latching solenoid.

20. The method of claim 14, wherein actuating the backup brake actuator comprises actuating the first locking valve internal to the brake control module or external to the brake control module.
